(19) United States
(12) Patent Application Publication
(10) Pub. No.: US 2023/0052345 A1
(43) Pub. Date: Feb. 16, 2023

(54) METHOD FOR RECYCLING SPENT REDUCTION GAS IN A DIRECT REDUCTION OF IRON ORE SYSTEM UTILIZING AN ELECTRIC GAS HEATER

(71) Applicant: Midrex Technologies, Inc., Charlotte, NC (US)

(72) Inventors: Haruyasu Michishita, Charlotte, NC (US); Todd Astoria, Harrisburg, NC (US); Enrique Jose Cintron, Charlotte, NC (US)

(21) Appl. No.: 17/884,070

(22) Filed: Aug. 9, 2022

Related U.S. Application Data
(60) Provisional application No. 63/232,748, filed on Aug. 13, 2021.

(51) Int. Cl. C21B 13/02; C21B 13/00

(52) U.S. Cl. CPC C21B 13/026; C21B 13/0073; C21B 2100/44

(57) ABSTRACT

A process for producing direct reduced iron with a hydrogen rich gas, utilizing a non-fired reducing gas heater such as an electric heater to heat the reducing gas to the temperatures sufficient for iron reduction, includes: providing a shaft furnace to reduce iron oxide with the hydrogen rich reducing gas; removing steam and particulates from the shaft furnace top gas with a scrubber; processing all or a portion of the scrubbed top gas in a gas separation unit such as a membrane and a PSA gas separation unit to create a hydrogen rich stream to be recycled back to the shaft furnace as the reducing agent, so that the hydrogen consumption can be reduced when non-fired reducing gas heater is applied.

### CROSS-REFERENCE TO RELATED APPLICATION

The present non-provisional patent application claims the benefit of priority of U.S. Provisional Patent Application No. 63/232,748, filed on Aug. 13, 2021, and entitled “METHOD FOR RECYCLING SPENT REDUCTION GAS IN A DIRECT REDUCTION OF IRON ORE SYSTEM UTILIZING AN ELECTRIC GAS HEATER,” the contents of which are incorporated in full by reference herein.

### TECHNICAL FIELD

The present disclosure relates generally to the direct reduced iron (DRI) and steelmaking fields. More specifically, the present disclosure relates to a method and system to produce direct reduced iron (DRI) in which reducing gas is heated using means other than combustion.

### BACKGROUND

Direct reduced iron (DRI), often referred to as sponge iron, is typically produced by reacting iron ore with syngas, a gas containing hydrogen and carbon monoxide. In conventional processes, the syngas is generated from natural gas either by reforming it in situ within the reduction furnace or in a separate catalytic reformer. In this case, DRI refers to any of the common product forms such as Cold Direct Reduced Iron (CDRI), Hot Direct Reduced Iron (HDRI), Hot Briquetted Iron (HBI), or any other DRI that is produced by gas-based reduction of iron ore in a shaft furnace.

As part of global efforts to combat climate change, the steel sector seeks to reduce or eliminate its CO₂ emissions. In conventional ironmaking, the largest share of CO₂ emissions originates during the reduction of iron ore where iron oxide is reduced to metallic iron with coal in the case of the blast furnace and natural gas in the case of a direct reduction furnace. The input of fossil fuels is used not only to provide the chemistry needed for reduction, but to also supply the energy required for driving the reaction. In the case of direct reduction, hydrogen produced from green sources, what we call green hydrogen, can potentially serve as a replacement for natural gas greatly diminishing emissions during the reduction phase of ironmaking.

While considerable efforts have been placed on developing and refining conventional processes for use with green hydrogen, significant difficulties remain. One major issue is the large consumption of hydrogen required by conventional processes. Because conventional reduction technologies rely on fired heaters to supply the energy for reduction, sufficient hydrogen must be added not only for reduction reaction requirements, but also to meet the process heat requirements via combustion. This can have a negative impact on costs as additional electrolysis capacity must be installed and additional electricity must be used.

Accordingly, there is a need for improved methods and systems to produce direct reduced iron (DRI) in which reducing gas is heated using means other than combustion.

### BRIEF SUMMARY OF THE INVENTION

Embodiments of the present invention improve upon prior methods and systems of producing direct reduced iron (DRI). For instance, it has been determined that an electric gas heater using electricity derived from renewable energy, which is also used to produce green hydrogen with electrolysis, can be a typical example to reduce CO₂ emissions.

Thus, it advantageously has herein been determined that replacing the fired reducing gas heater used in conventional technologies with an electric version can decrease not only the green hydrogen required, but also the electricity needed in total. The electricity consumption for the electric reducing gas heater is significantly less than the amount of electricity required to generate the hydrogen used by a fired reducing gas heater, due to the lower heat efficiency of the fired heater. Adiabatic hydrogen combustion gas in heating the reducing gas up to 800˜1000° C. typically required for the iron oxide reduction, provides only 40˜50% net available energy since 50˜60% energy is taken away by the combustion flue gas. On the other hand, the efficiency of the electric heating is typically higher than 90% since it has only mechanical and electrical energy loss.

It has been further determined that processes in the state-of-the-art are not compatible with electric heating. For instance, in the direct reduction furnace, excess non-condensable inert and oxidant gas must be removed from the process to prevent the buildup in the main process gas loop. Currently this is done by purging a portion of the spent gas, referred to as Top Gas Fuel in the MIDREX® Process (see FIG. 1), to be used as fuel for the reformer/heater. In the state-of-art direct reduction process using a reformer with natural gas, to compensate the gas volume expansion resulting from the reforming reaction, Top Gas Fuel flow can be as high as ⅓ of the top gas, meaning that ⅔ of the gas is recycled on a per pass basis. At the modern Midrex Plant with natural gas, however, the amount of generated Top Gas Fuel is well balanced with the fuel gas requitement with the reformer and little fuel gas makeup is required.

In the state-of-art direct reduction process with hydrogen close to 100%, we have the similar situation when trying to produce DRI containing the carbon, a desirable property for downstream melting, by introducing carbonaceous gas such as natural gas. In this situation, typically 10˜20% of the shaft furnace top gas must be purged as Top Gas Fuel, depending on the target carbon content in DRI, to remove the non-condensable oxidant such as CO₂ with a lack of CO₂ reforming where CO₂ can be converted to CO to reuse within the reduction furnace. The hydrogen reduction process without the reformer will generate purged Top Gas Fuel containing a lot of valuable green hydrogen leftover, as well as CO and CO₂, which ought to be used by the fired reducing gas heater with fuel gas makeup such as hydrogen or natural gas makeup. Therefore, the hydrogen reduction processes to produce DRI containing carbon in the state-of-the-art need to maintain the fired reducing gas heater to use Top Gas Fuel and tolerate the higher fuel gas consumption in producing the DRI containing a carbon.

There exist methods and systems to remove CO₂ from the Top Gas, but these also prove limited in effect when hydrogen is used as the primary gas for reduction. The small quantity of CO₂ in the shaft furnace top gas limits the performance of conventional gas separation technologies such as amine scrubbers and pressure swing adsorption unit operations. The low concentration of CO₂ in the gas stream can lead to relatively large CO₂ capture unit operations with less efficiency or more hydrogen slip to the disposed gas for this application. Examples in the field also show high integration with fired heaters as these again are used to handle the disposed gases and utilize leftover heating value for the process.

In case of a 100% hydrogen reduction to produce the zero-carbon DRI without the carbonaceous gas introduction, the purge portion of the shaft furnace top gas is not as large as the former case. Non-condensable inert gas such as nitrogen, however, must be removed to prevent the buildup in the process gas loop as Top Gas Fuel, the major fraction of which is hydrogen. The purged Top Gas Fuel ought to be used by the fired reducing gas heater unless there exist other appropriate consumers or just vented through a flare system, which increases the amount of H₂ consumption as in the former case.

Thus, in embodiments of the invention, the present disclosure provides a method and system for the production of DRI from hydrogen utilizing a non-fired, such as an electric heating, mechanism while significantly improving the energy efficiency compared to the current state-of-the-art technologies with the fired heating.

In various embodiments, the present disclosure provides new methods and systems to recycle spent Top Gas from the reduction shaft furnace and manage buildup of non-condensable inert and oxidant gas within the main recycle loop. Advantageously, the hydrogen consumption to reduce iron oxide is decreased as compared to existing technologies, thereby improving process efficiency.

In an exemplary embodiment, a method for recycling spent reduction gas in a direct reduction of iron ore system utilizing a non-fired reducing gas heater, such as an electric gas heater, to heat the reducing gas to the temperatures sufficient for iron reduction, comprises:
a. providing a shaft furnace of a direct reduction plant to reduce iron oxide to metallic iron with a hydrogen rich reducing gas;
b. removing steam and particulates from the spent reduction gas with a scrubber to process the shaft furnace top gas;
c. processing all or a portion of the scrubbed top gas in a gas separation unit to create a hydrogen rich stream with its fraction of non-hydrogen compounds reduced and an inert/oxidant rich stream containing CO₂, CO, CH₄, H₂, N₂ and other compounds; and
d. recycling the hydrogen rich stream from gas separation and remaining portion of the scrubbed top gas with fresh hydrogen to create the hydrogen rich reducing gas for the process.

In some embodiments, in producing the DRI containing a carbon with the carbon depositing gas fed into the transition zone of the shaft furnace, the gas added to the transition zone is created by blending together a portion of the inert/oxidant rich stream generated in the gas separation with an external carbon depositing gas.

In some embodiments, the method further comprises selectively removing all or a portion of CO₂ from the inert/oxidant rich stream prior to blending to create the transition zone gas.

In some embodiments, the method comprises processing all or a portion of the scrubbed top gas in a pressure swing adsorption (PSA) gas separation unit to generate two (2) gas streams; a hydrogen/nitrogen rich stream and a methane/oxidant rich stream, selectively recovering a hydrogen rich stream from the hydrogen/nitrogen rich stream with a membrane gas separation unit prior to recycling the hydrogen rich stream back to the main process gas loop, and/or selectively recovering a methane from the methane/oxidant rich stream with a membrane gas separation unit prior to directing to the transition zone after blending with an external carbon depositing gas.

In another exemplary embodiment, the present invention provides a process for producing direct reduced iron with a hydrogen rich reducing gas, utilizing a non-fired reducing gas heater to heat the hydrogen rich reducing gas to a temperature sufficient for iron reduction. The process comprises providing a reduction shaft furnace of a direct reduction plant to reduce iron oxide to metallic iron with the hydrogen rich reducing gas; providing a reduction shaft furnace top gas stream comprising spent reducing gas to a scrubber for removing steam and particulates from the spent reducing gas with the scrubber to process the shaft furnace top gas and produce a scrubbed top gas; processing all or a portion of the scrubbed top gas in a gas separation unit to create a hydrogen rich stream with its fraction of non-hydrogen compounds reduced, and an inert/oxidant rich stream comprising CO₂, CO, CH₄, H₂ and N₂; and recycling the hydrogen rich stream from the gas separation unit and at least a portion of the scrubbed top gas with hydrogen makeup or feedstock supply from another hydrogen rich stream to create the hydrogen rich reducing gas introduced to the shaft furnace, wherein prior to introduction into the shaft furnace, the hydrogen rich reducing gas is heated in the non-fired reducing gas heater to heat the hydrogen rich reducing gas to 800˜1100° C. The process may comprise injecting a portion of the inert/oxidant rich stream removed from the gas separation unit into a transition zone of the shaft furnace to carburize the direct reduced iron, after being blended with a hydrocarbon bearing gas. The process may comprise providing a CO₂ stripper; processing all or a portion of the inert/oxidant rich stream removed from the gas separation unit with the CO₂ stripper to recover purified CO₂; and injecting a portion of a lean CO₂ gas discharged from the CO₂ stripper into a transition zone of the shaft furnace to carburize the direct reduced iron, after being blended with a hydrocarbon bearing gas. The gas separation unit may be a membrane gas separator, a pressure swing adsorption gas separation unit or a cryogenic gas separation unit. The CO₂ stripper may be an amine absorber/stripper or a pressure swing adsorption gas separation unit. The non-fired reducing gas heater may be an electric heater using electric energy.

In another exemplary embodiment, a process for producing direct reduced iron with a hydrogen rich reducing gas, utilizing a non-fired reducing gas heater to heat the hydrogen rich reducing gas to a temperature sufficient for iron reduction, comprises providing a reduction shaft furnace of a direct reduction plant to reduce iron oxide to metallic iron with the hydrogen rich reducing gas; providing a reduction shaft furnace top gas stream comprising spent reducing gas to a scrubber for removing steam and particulates from the spent reducing gas with the scrubber to process the shaft furnace top gas and produce a scrubbed top gas; processing all or a portion of the scrubbed top gas in a pressure swing adsorption gas separation unit to create a dry hydrogen/nitrogen rich stream with its fraction of non-hydrogen or non-nitrogen compounds reduced, and a methane/oxidant rich stream comprising CH₄, CO₂, CO, H₂O, CH₄, H₂ and N₂; further processing the dry hydrogen/nitrogen rich stream in a membrane gas separation unit to recover a hydrogen rich stream; and recycling the hydrogen rich stream from the membrane gas separation unit and at least a portion of the scrubbed top gas with hydrogen from another hydrogen rich stream to create the hydrogen rich reducing gas introduced to the shaft furnace, wherein prior to introduction into the shaft furnace, the created hydrogen rich reducing gas is heated in the non-fired reducing gas heater to heat the hydrogen rich reducing gas to 800˜1100° C. The non-fired reducing gas heater may be an electric heater using electric energy.

In a further exemplary embodiment, a process for producing direct reduced iron with a hydrogen rich reducing gas, utilizing a non-fired reducing gas heater to heat the hydrogen rich reducing gas to a temperature sufficient for iron reduction, comprises providing a reduction shaft furnace of a direct reduction plant to reduce iron oxide to metallic iron with the hydrogen rich reducing gas; providing a reduction shaft furnace top gas stream comprising spent reducing gas to a scrubber for removing steam and particulates from the spent reducing gas with the scrubber to process the shaft furnace top gas and produce a scrubbed top gas; processing all or a portion of the scrubbed top gas in a pressure swing adsorption gas separation unit to create a dry hydrogen/nitrogen rich stream with its fraction of non-hydrogen or non-nitrogen compounds reduced, and a methane/oxidant rich stream comprising CH₄, CO₂, CO, H₂O, CH₄, H₂ and N₂; further processing the methane/oxidant rich stream in a membrane gas separation unit to create a methane rich stream; and injecting the methane rich stream from the membrane gas separation unit into a transition zone of the shaft furnace to carburize the direct reduced iron, after being blended with a hydrocarbon bearing gas. The process may comprise recycling the hydrogen rich stream from the gas separation unit and at least a portion of the scrubbed top gas with hydrogen from another hydrogen rich stream to create the hydrogen rich reducing gas introduced to the shaft furnace, wherein prior to introduction into the shaft furnace, the hydrogen rich reducing gas is heated in the non-fired reducing gas heater to heat the hydrogen rich reducing gas to 800˜1100° C. The non-fired reducing gas heater may an electric heater using electric energy.

In another exemplary embodiment, a system for producing direct reduced iron with a hydrogen rich reducing gas, utilizing a non-fired reducing gas heater to heat the hydrogen rich reducing gas to a temperature sufficient for iron reduction, comprises a reduction shaft furnace of a direct reduction plant configured to reduce iron oxide to metallic iron with the hydrogen rich reducing gas; a scrubber configured to receive a reduction shaft furnace top gas stream comprising spent reducing gas and remove steam and particulates from the spent reducing gas with the scrubber to process the shaft furnace top gas and produce a scrubbed top gas; a gas separation unit configured to process all or a portion of the scrubbed top gas to create a hydrogen rich stream with its fraction of non-hydrogen compounds reduced, and an inert/oxidant rich stream comprising CO₂, CO, CH₄, H₂ and N₂; and a recycle line configured to recycle the hydrogen rich stream from the gas separation unit and at least a portion of the scrubbed top gas with hydrogen from another hydrogen rich stream to create the hydrogen rich reducing gas introduced to the shaft furnace, wherein prior to introduction into the shaft furnace, the hydrogen rich reducing gas is configured to be heated in the non-fired reducing gas heater to heat the hydrogen rich reducing gas to 800˜1100° C. The system may comprise a compressor configured to pressurize the scrubbed top gas. The system may comprise another recycle line configured to inject a portion of the inert/oxidant rich stream removed from the gas separation unit into a transition zone of the shaft furnace to carburize the direct reduced iron, after being blended with a hydrocarbon bearing gas. The system may comprise a CO₂ stripper configured to recover purified CO₂ from the inert/oxidant rich stream discharged from the gas separation unit for the scrubbed top gas. The gas separation unit may be a membrane gas separator, a pressure swing adsorption gas separation unit or a cryogenic gas separation unit. The CO₂ stripper may be an amine absorber or a pressure swing adsorption gas separation unit. The non-fired reducing gas heater may be an electric heater using electric energy.

In a further exemplary embodiment, a system for producing direct reduced iron with a hydrogen rich reducing gas, utilizing a non-fired reducing gas heater to heat the hydrogen rich reducing gas to a temperature sufficient for iron reduction, comprises a reduction shaft furnace of a direct reduction plant configured to reduce iron oxide to metallic iron with the hydrogen rich reducing gas; a scrubber configured to receive a reduction shaft furnace top gas stream comprising spent reducing gas and remove steam and particulates from the spent reducing gas with the scrubber to process the shaft furnace top gas and produce a scrubbed top gas; a pressure swing adsorption gas separation unit configured to process all or a portion of the scrubbed top gas to create a dry hydrogen/nitrogen rich stream with its fraction of non-hydrogen or non-nitrogen compounds reduced, and a methane/oxidant rich stream comprising CH₄, CO₂, CO, H₂O, CH₄, H₂ and N₂; a secondary membrane gas separation unit configured to process the dry hydrogen/nitrogen rich stream and create hydrogen rich stream; and a recycle line configured to recycle the hydrogen rich stream from the secondary membrane gas separation unit and at least a portion of the scrubbed top gas with hydrogen from another hydrogen rich stream to create the hydrogen rich reducing gas introduced to the shaft furnace, wherein prior to introduction into the shaft furnace, the hydrogen rich reducing gas is configured to be heated in the non-fired reducing gas heater to heat the hydrogen rich reducing gas to 800˜1100° C. The system may further comprise a compressor configured to pressurize the scrubbed top gas. The non-fired gas heater may be an electric heater using electric energy.

In another exemplary embodiment, a system for producing direct reduced iron with a hydrogen rich reducing gas, utilizing a non-fired reducing gas heater to heat the hydrogen rich reducing gas to a temperature sufficient for iron reduction, comprises a reduction shaft furnace of a direct reduction plant configured to reduce iron oxide to metallic iron with the hydrogen rich reducing gas; a scrubber configured to receive a reduction shaft furnace top gas stream comprising spent reducing gas and remove steam and particulates from the spent reducing gas with the scrubber to process the shaft furnace top gas and produce a scrubbed top gas; a pressure swing adsorption gas separation unit configured to process all or a portion of the scrubbed top gas to create a dry hydrogen/nitrogen rich stream with its fraction of non-hydrogen or non-nitrogen compounds reduced, and a methane/oxidant rich stream comprising CH₄, CO₂, CO, H₂O, CH₄, H₂ and N₂; a secondary membrane gas separation unit configured to process the methane/oxidant rich stream to create a methane rich stream; and an injection line configured to inject the methane rich stream from the membrane gas separation unit into a transition zone of the shaft furnace to carburize the direct reduced iron, after being blended with a hydrocarbon bearing gas. The non-fired reducing gas heater may be an electric heater using electric energy.

### BRIEF DESCRIPTION OF THE DRAWINGS

The present disclosure is illustrated and described with reference to the various drawings, in which:

FIG. 1 is a schematic diagram illustrating afore-referenced MIDREX® Process;

FIG. 2 is a schematic diagram illustrating one exemplary embodiment of the method and system of the present disclosure for recycling spent reduction gas where a portion of the Top Gas is pressurized and sent to a membrane separation unit in which hydrogen is recovered back to the main process loop and the removed non-condensable inert and oxidant gas stream is directed to, e.g., a flare system to vent;

FIG. 3 is a schematic diagram illustrating another exemplary embodiment of the method and system of the present disclosure for recycling spent reduction gas where a portion of the Top Gas is pressurized and sent to a membrane separation unit in which hydrogen is recovered back to the main process loop and the removed non-condensable inert and a portion of the oxidant gas stream is blended with hydrocarbon bearing gas for injection into the transition zone of the reduction shaft furnace;

FIG. 4 is a schematic diagram illustrating another exemplary embodiment of the method and system of the present disclosure for recycling spent reduction gas where a portion of the Top Gas is pressurized and sent to a multistage separation unit including a PSA and an amine scrubber in which hydrogen is recovered back to the main process loop, high purity (e.g., at least 95%) carbon dioxide is recovered in the amine scrubber, and a remaining portion of the lean CO₂ stream is blended with hydrocarbon bearing gas for injection into the transition zone of the reduction shaft furnace; and

FIG. 5 is a schematic diagram illustrating another exemplary embodiment of the method and system of the present disclosure for recycling spent reduction gas where a portion of the Top Gas is pressurized and sent to a multistage separation unit including a PSA and membrane separation units. The hydrogen/nitrogen rich gas recovered with the PSA unit is further processed with the membrane unit to remove nitrogen, in which the hydrogen is recycled to the main process loop and the nitrogen is directed to, e.g., a flare system to vent. The methane/oxidant rich stream removed with the PSA is further processed with the membrane unit to recover methane, in which the methane rich stream is injected into the transition zone with the makeup of hydrocarbon bearing gas and the remaining gas stream of the membrane unit is directed to a flare system to vent.

### DETAILED DESCRIPTION OF EMBODIMENTS

Again, in various exemplary embodiments, the present disclosure advantageously provides a method and system for the production of DRI from hydrogen utilizing electric heating while significantly improving the energy efficiency compared to the current state-of-the-art technologies. Further, in various embodiments of the disclosure, new methods and systems are provided to recycle spent Top Gas from the reduction shaft furnace and manage buildup of non-condensable inert and oxidant gas within the main recycle loop, where the inert gas buildup is mainly caused by the nitrogen in seal gas used at the material charge/discharge system in the shaft furnace and the non-condensable oxidant gas buildup is mainly caused by CO₂, especially in case that the carbonaceous gas is introduced to produce the DRI containing carbon. Advantageously, the hydrogen consumption to reduce iron oxide is decreased as compared to existing technologies, thereby managing the buildup of non-condensable inert and oxidant gas and improving process efficiency.

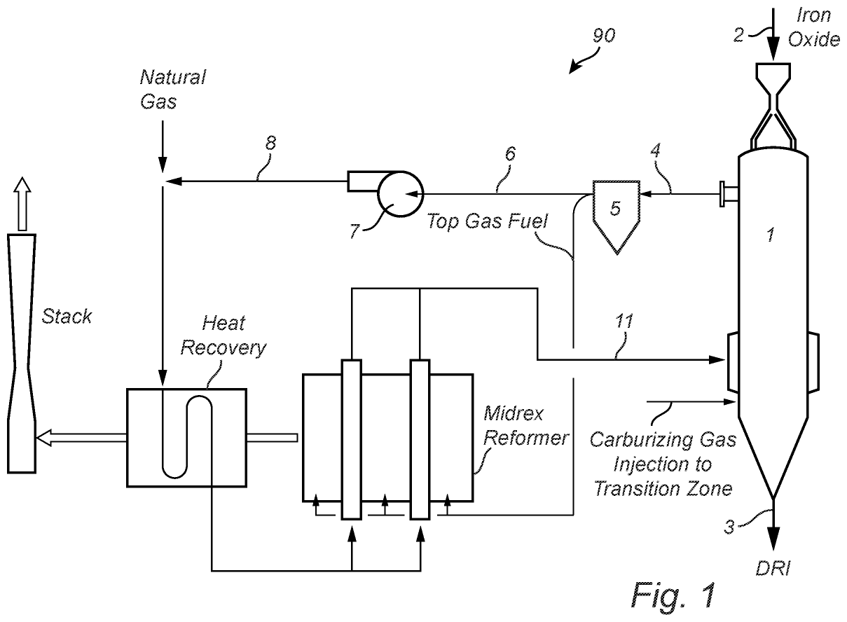

Referring now specifically to FIG. 1, system/method 90 depicts the state-of-art direct reduction process using natural gas. Iron oxide 2 is charged from the top of shaft furnace 1 and reduced to DRI 3 discharged from the bottom of the shaft furnace 1, where the hot reducing gas 11 produced by the MIDREX Reformer is introduced in the bustle of the shaft furnace 1. The shaft furnace top gas 4 containing much reduction products such as H₂O and CO₂ is processed with the top gas scrubber 5, where the top gas is cooled to reduce H₂O content and the particulates are removed from the top gas. A portion of the scrubbed top gas needs to be purged and used as fuel for the reformer/heater, referred to as Top Gas Fuel in the MIDREX Process, to remove the excess non-condensable inert and oxidant such as nitrogen and CO₂ remaining in the recycled gas. In the conventional MIDREX Process with the efficient reformer which converts CO₂ to CO to reuse within the reduction furnace, to compensate the gas volume expansion resulting from the reforming reaction, the ratio of the purge gas after the scrubber can be as high as ⅓ of the top gas meaning that only ⅔ of the gas may be recycled on a per pass basis.

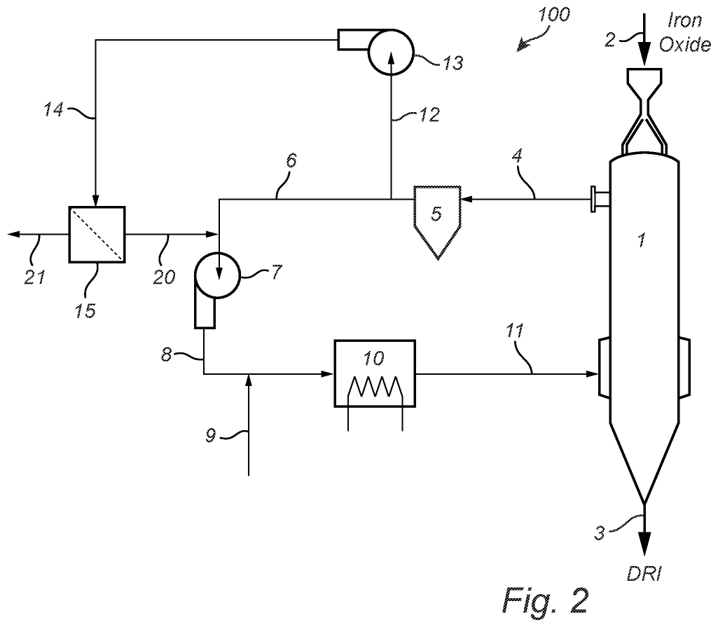

Referring now specifically to FIG. 2, for the production of DRI from hydrogen, system/method 100 depicted therein is configured to recycle spent reduction gas where a portion of the scrubbed top gas is purged, pressurized, and sent to a membrane separation unit in which hydrogen is recovered back to the main process gas loop and the removed non-condensable inert and oxidant gas stream is directed to, e.g., a flare system.

In one exemplary embodiment, the shaft furnace top gas 4 having much reduction products as in the MIDREX process of FIG. 2 such as H₂O and CO₂, is processed with the scrubber 5, in which the gas is cooled to reduce the H₂O content and the particulates are removed from the top gas. To remove the excess non-condensable inert and oxidant such as CO₂ and manage the buildup in the main process gas loop, a portion of the scrubbed top gas 12 is purged, where typically 10˜20% of the shaft furnace top gas must be purged, depending on the target carbon content in DRI. The purged top gas is pressurized by the compressor 13 and sent to a membrane gas separation unit 15 via stream 14. Two gas streams are generated from the gas separation unit 15, a hydrogen rich stream 20 and an inert/oxidant rich stream 21. The hydrogen rich stream 20, which typically comprises more than 90% hydrogen, is recovered back to the main process loop and mixed with the remaining scrubber outlet gas 6. These gas mixtures are pressurized by Process Gas Compressors 7 followed by the making up with the fresh hydrogen stream 9 to remake the reducing gas 11. The reducing gas 11 is heated in an electric heater 10 or other suitable non-fired heating device up to the temperature typically 800˜1000° C. required for the iron oxide reduction in the shaft furnace 1. This mixing point for the hydrogen rich stream 20 with the scrubber outlet gas 6 can occur either before or after the Process Gas Compressors 7 depending on the pressure balance. The inert/oxidant rich stream 21, which is the dry gas typically comprising more than 70% non-hydrogen compounds, is either utilized by other site users or combusted via conventional means such as in a flare or thermal oxidizer.

In case of a 100% hydrogen reduction to produce the zero-carbon DRI without the carbonaceous gas introduction, the amount of the inert/oxidant rich stream 21 is smaller than that in producing the DRI containing the carbon although the amount depends on nitrogen content left in the reducing gas 11. The hydrogen rich stream 20 typically comprises more than 90% hydrogen and the inert/oxidant rich stream 21 typically comprises nitrogen and some H₂ slipped. Therefore, the system/method 100 of FIG. 2 may be likely applied to decrease the hydrogen consumption.

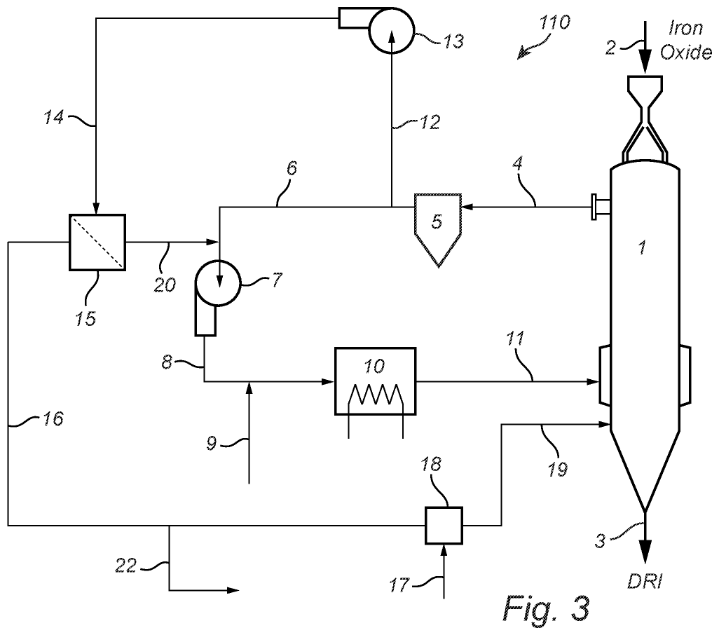

Referring now specifically to FIG. 3, system/method 110 depicted therein is configured to recycle spent reduction gas where a portion of the scrubbed top gas is purged, pressurized, and sent to a membrane separation unit in which hydrogen is recovered back to the main process gas loop. A portion of the removed non-condensable inert and oxidant gas stream is blended with hydrocarbon bearing gas before injecting into a transition zone of the shaft furnace. This configuration is advantageous for the hydrogen reduction process when trying to product DRI containing the carbon by introducing carbonaceous gas such as natural gas into the transition zone of the reduction shaft furnace.

In one exemplary embodiment shown in FIG. 3 and similar to FIG. 2, the purged scrubbed top gas 12 is pressurized by the compressor 13 and sent to a membrane gas separation unit 15 via stream 14. Two gas streams are generated from the gas separation unit 15, hydrogen rich stream 20 and an inert/oxidant rich stream 16 (see 21 of FIG. 2). The hydrogen rich stream 20 typically comprises more than 90% hydrogen. The inert/oxidant rich stream 16 is the dry gas typically comprising more than 70% non-hydrogen compounds including methane and CO having the carburizing potential of DRI. The difference from FIG. 2 is to here direct the inert/oxidant rich stream to the shaft furnace transition zone as shown in FIG. 3 for reuse as carburizing gas, instead of sending to other users or combusting in a flare or thermal oxidizer as in FIG. 2. To avoid the buildup of the inert and oxidant gas such as N₂ and CO₂ in the process gas loop, a portion of the inert/oxidant rich stream 16 can be purged as shown in the stream 22, which is directed to external uses or can be combusted via conventional means such as in a flare or thermal oxidizer. A remaining portion of the inert/oxidant rich stream 16 is directed to the transition zone in the carburizing gas stream 19 after a carbon favoring gas 17, such as natural gas, is added at a gas mixer 18.

Different gases as desired can be supplied for making the transition zone blend at gas mixer 18. A main factor in selecting gas composition is in its ability to deposit carbon on iron at temperatures above 650° C. Suitable gases include those with medium to high levels of methane and heavier hydrocarbons. Gases with low levels of methane can be used as well, but at a potential sacrifice of some level of carbon on the product DRI.

The needed amount of the inert/oxidant rich gas purging in stream 21 of FIG. 2 or stream 22 in FIG. 3 is determined by the buildup of the inert and oxidant gas in the process gas loop. In case of a 100% hydrogen reduction to produce the zero-carbon DRI without the carbonaceous gas introduction, the amount of the stream 21 in FIG. 2 will be likely adjusted with the nitrogen content in the reducing gas stream 11. In case of producing the DRI containing a carbon, the amount of the stream 21 in FIG. 2 will be likely adjusted with the CO₂ content in the reducing gas stream 11 and the amount of the stream 22 in FIG. 3 will be likely adjusted with the CO₂ content in the carburizing gas stream 19 as well as the CO₂ content in the reducing gas stream 11. The amount of the gas purging can be reduced, and the hydrogen consumption can be further improved by further removing the inert and oxidant from the inert/oxidant rich stream 16 before directing to the shaft furnace transition zone, as also mentioned below.

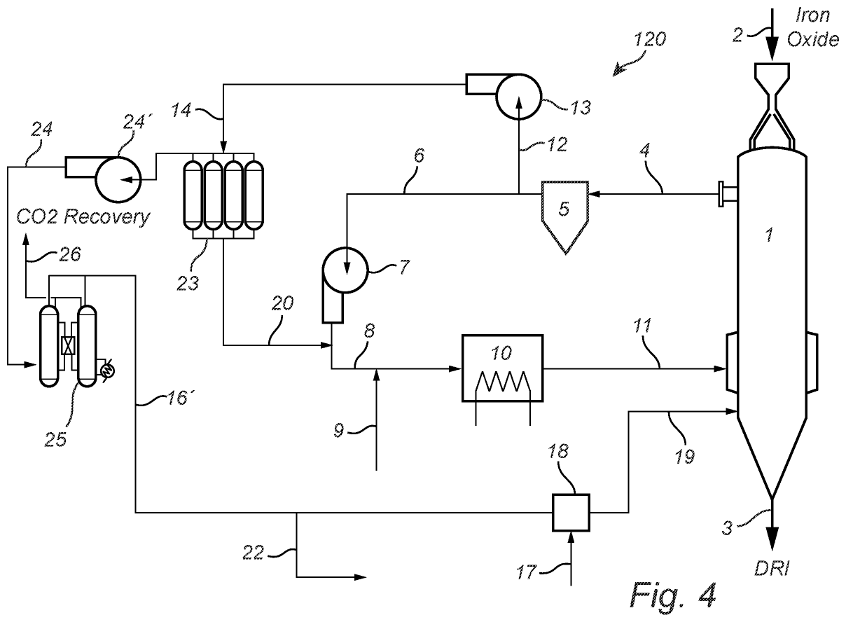

Referring now specifically to FIG. 4, system/method 120 depicted therein is configured to recycle spent reduction gas where a portion of the scrubbed top gas is pressurized and sent to a pressure swing adsorption (PSA) and an amine scrubber in which hydrogen is recovered back to the main process loop, high purity carbon dioxide is recovered in the amine scrubber, and a portion of the remaining CO₂ lean gas stream is blended with hydrocarbon bearing gas before injecting into the transition zone of the reduction shaft furnace.

In one exemplary embodiment, the purged scrubbed top gas 12 is pressurized by the compressor 13 and sent to pressure swing adsorption (PSA) unit 23 via stream 14. Two gas streams are generated (similar to FIGS. 2 and 3), hydrogen rich stream 20 and an inert/oxidant rich stream 24 (21 of FIG. 2). The hydrogen rich stream 20 is the dry gas typically comprising more than 90% hydrogen to be recovered back to the main process loop and mixed with the remaining scrubber outlet gas 6. These gas mixtures are pressurized by Process Gas Compressor 7 followed by the making up with the fresh hydrogen stream 9 to remake the reducing gas 11. The reducing gas 11 is heated in an electric heater 10 or other suitable electric heating device up to the desired temperature typically 800˜1000° C. for the iron oxide reduction in the shaft furnace 1. This mixing point for the hydrogen rich stream 20 with the remaining scrubber outlet gas 6 can occur either before or after the Process Gas Compressor 7 depending on the pressure balance.

A portion or all of the inert/oxidant rich stream 24, typically comprising more than 70% non-hydrogen compounds such as N₂, CO, CO₂, H₂O and methane, is pressurized with compressor 24′ and directed to an amine absorber/stripper unit 25 for further processing. A high purity CO₂ stream 26 typically comprising more than 99% CO₂ in dry basis, is recovered for external uses. Some examples of potential uses include utilizing the CO₂ in another process or sequestration in long term storage. To manage the buildup of N₂ and CO₂ in the main process gas loop, a portion of remaining CO₂ lean gas 16′ from the amine absorber/stripper unit 25 is purged in stream 22. Thereafter, the remaining portion of CO₂ lean gas 16′ is directed to the transition zone of the reduction shaft furnace 1 in stream 19 after a carbon favoring gas 17, such as natural gas, is added at a gas mixer 18. Purge stream 22 is located either upstream or downstream the amine absorber/stripper unit 25 to maintain N₂ and CO₂ levels in the main gas loop and directed to external uses or can be combusted via conventional means such as in a flare or thermal oxidizer.

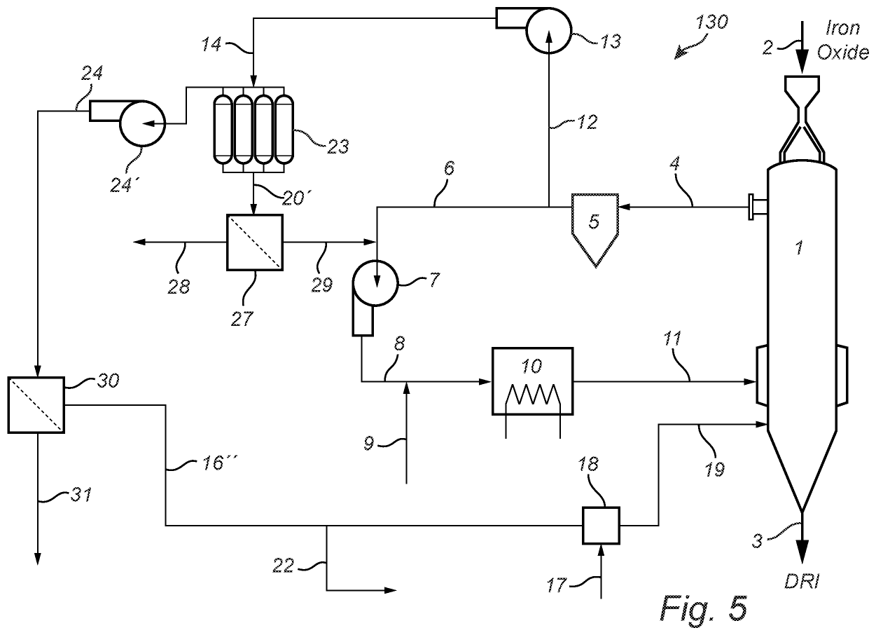

Referring now specifically to FIG. 5, system/method 130 depicted therein is configured to recycle spent reduction gas where a portion of the scrubbed top gas is pressurized and sent to a pressure swing adsorption (PSA) unit via stream 14 followed by several membrane gas separation units to recover hydrogen and methane rich gas after removing N₂ and CO₂. The hydrogen is recovered back to the main process gas loop. The methane rich gas is directed to gas mixer 18 and made up by the additional hydrocarbon bearing gas 17 before injecting into the transition zone of reduction shaft furnace 1 via stream 19.

In one exemplary embodiment as also shown in FIG. 5, the purged scrubbed top gas 12 is pressurized by the compressor 13 and sent to pressure swing adsorption (PSA) unit 23, where two gas streams are generated, a hydrogen/nitrogen rich stream 20′ and a methane/oxidant rich stream 24. The hydrogen/nitrogen rich stream 20′ is the dry gas typically comprising more than 90% hydrogen/nitrogen to be sent to a membrane gas separation unit 27 to separate hydrogen rich gas 29 and nitrogen rich gas 28. Hydrogen rich gas 29 is recovered back to the main process loop and mixed with the remaining scrubber outlet gas 6. Nitrogen rich gas 28 is sent to, e.g., a flare to vent. The methane/oxidant rich stream 24, typically comprising more than 70% non-hydrogen compounds such as CO, CO₂, H₂O and methane, is pressurized with the compressor 24′ to be sent to another membrane gas separation unit 30 to separate methane rich stream 16″ and the remaining oxidant gas stream 31. The methane rich stream 16″ is directed to gas mixer 18 and made up by the additional hydrocarbon bearing gas 17 before injecting into the transition zone via stream 19 to product DRI containing the carbon. The remaining oxidant gas stream 31 is sent to, e.g., a flare to vent.

The system/method 130 shown FIG. 5 comprises the multiple gas separation units to advantageously minimize the amount of vent gas to manage the buildup of CO₂ and N₂ and maximize the recovery rate of hydrogen and methane. The methane rich stream 16″ of FIG. 5 from the membrane gas separation unit 30 is dry gas comprising mostly methane with minimal CO₂ and suitable to carburize the DRI in the shaft furnace. Also, reusing the recovered methane to inject into the transition zone will effectively reduce CO₂ emission, compared with the state-of-art technology.

Thus, according to advantageous embodiments, disclosed is a process/system for producing direct reduced iron with a hydrogen rich gas, utilizing a non-fired reducing gas heater such as an electric heater to heat the reducing gas to the temperatures sufficient for iron reduction. The process can include providing a shaft furnace to reduce iron oxide with the hydrogen rich reducing gas; removing steam and particulates from the shaft furnace top gas with a scrubber; processing all or a portion of the scrubbed top gas in a gas separation unit such as a membrane and a PSA gas separation unit to create a hydrogen rich stream to be recycled back to the shaft furnace as the reducing agent, so that the hydrogen consumption can be reduced when the non-fired reducing gas heater is applied and none consumes the shaft furnace top gas purged to manage the buildup of non-condensable inert and oxidant gas in the process gas loop. The process can be further optimized to increase the recycled amount of hydrogen as well as methane with the secondary gas separation units when a carbonaceous gas such as natural gas is introduced to the plant operating at close to 100% hydrogen and operating to produce DRI containing the carbon.

Although the present invention is illustrated and described herein with reference to particular and preferred embodiments, and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following non-limiting claims. Moreover, all features, elements and embodiments described herein may be used in any combinations.

What is claimed is:

1. A process for producing direct reduced iron with a hydrogen rich reducing gas, utilizing a non-fired reducing gas heater to heat the hydrogen rich reducing gas to a temperature sufficient for iron reduction, comprising:
providing a reduction shaft furnace of a direct reduction plant to reduce iron oxide to metallic iron with the hydrogen rich reducing gas;
providing a reduction shaft furnace top gas stream comprising spent reducing gas to a scrubber for removing steam and particulates from the spent reducing gas with the scrubber to process the shaft furnace top gas and produce a scrubbed top gas;
processing all or a portion of the scrubbed top gas in a gas separation unit to create a hydrogen rich stream with its fraction of non-hydrogen compounds reduced, and an inert/oxidant rich stream comprising CO₂, CO, CH₄, H₂ and N₂; and
recycling the hydrogen rich stream from the gas separation unit and at least a portion of the scrubbed top gas with hydrogen makeup from another hydrogen rich stream to create the hydrogen rich reducing gas introduced to the shaft furnace, wherein prior to introduction into the shaft furnace, the hydrogen rich reducing gas is heated in the non-fired reducing gas heater to heat the hydrogen rich reducing gas to 800˜1100° C.

2. The process of claim 1, further comprising:
injecting a portion of the inert/oxidant rich stream removed from the gas separation unit into a transition zone of the shaft furnace to carburize the direct reduced iron, after being blended with a hydrocarbon bearing gas.

3. The process of claim 1, further comprising:
providing a CO₂ stripper;
processing all or a portion of the inert/oxidant rich stream removed from the gas separation unit with the CO₂ stripper to recover purified CO₂; and
injecting a portion of a lean CO₂ gas discharged from the CO₂ stripper into a transition zone of the shaft furnace to carburize the direct reduced iron, after being blended with a hydrocarbon bearing gas.

4. The process of claim 1, wherein the gas separation unit is a membrane gas separator.

5. The process of claim 1, wherein the gas separation unit is a pressure swing adsorption gas separation unit.

6. The process of claim 1, wherein the gas separation unit is a cryogenic gas separation unit.

7. The process of claim 3, wherein the CO₂ stripper is an amine absorber/stripper or a pressure swing adsorption gas separation unit.

8. A process for producing direct reduced iron with a hydrogen rich reducing gas, utilizing a non-fired reducing gas heater to heat the hydrogen rich reducing gas to a temperature sufficient for iron reduction, comprising:
providing a reduction shaft furnace of a direct reduction plant to reduce iron oxide to metallic iron with the hydrogen rich reducing gas;
providing a reduction shaft furnace top gas stream comprising spent reducing gas to a scrubber for removing steam and particulates from the spent reducing gas with the scrubber to process the shaft furnace top gas and produce a scrubbed top gas;
processing all or a portion of the scrubbed top gas in a pressure swing adsorption gas separation unit to create a dry hydrogen/nitrogen rich stream with its fraction of non-hydrogen or non-nitrogen compounds reduced, and a methane/oxidant rich stream comprising CH₄, CO₂, CO, H₂O, CH₄, H₂ and N₂;
further processing the dry hydrogen/nitrogen rich stream in a membrane gas separation unit to recover a hydrogen rich stream; and
recycling the hydrogen rich stream from the membrane gas separation unit and at least a portion of the scrubbed top gas with hydrogen from another hydrogen rich stream to create the hydrogen rich reducing gas introduced to the shaft furnace, wherein prior to introduction into the shaft furnace, the created hydrogen rich reducing gas is heated in the non-fired reducing gas heater to heat the hydrogen rich reducing gas to 800˜1100° C.

9. A process for producing direct reduced iron with a hydrogen rich reducing gas, utilizing a non-fired reducing gas heater to heat the hydrogen rich reducing gas to a temperature sufficient for iron reduction, comprising:
providing a reduction shaft furnace of a direct reduction plant to reduce iron oxide to metallic iron with the hydrogen rich reducing gas;
providing a reduction shaft furnace top gas stream comprising spent reducing gas to a scrubber for removing steam and particulates from the spent reducing gas with the scrubber to process the shaft furnace top gas and produce a scrubbed top gas;
processing all or a portion of the scrubbed top gas in a pressure swing adsorption gas separation unit to create a dry hydrogen/nitrogen rich stream with its fraction of non-hydrogen or non-nitrogen compounds reduced, and a methane/oxidant rich stream comprising CH₄, CO₂, CO, H₂O, CH₄, H₂ and N₂;
further processing the methane/oxidant rich stream in a membrane gas separation unit to create a methane rich stream; and
injecting the methane/oxidant rich stream from the membrane gas separation unit into a transition zone of the shaft furnace to carburize the direct reduced iron, after being blended with a hydrocarbon bearing gas.

10. The process of claim 9, comprising recycling the hydrogen rich stream from the gas separation unit and at least a portion of the scrubbed top gas with hydrogen from another hydrogen rich stream to create the hydrogen rich reducing gas introduced to the shaft furnace, wherein prior to introduction into the shaft furnace, the hydrogen rich reducing gas is heated in the non-fired reducing gas heater to heat the hydrogen rich reducing gas to 800˜1100° C.

11. The process of claim 1, wherein the non-fired reducing gas heater is an electric heater using electric energy.

12. The process of claim 8, wherein the non-fired reducing gas heater is an electric heater using electric energy.

13. The process of claim 9, wherein the non-fired reducing gas heater is an electric heater using electric energy.

14. A system for producing direct reduced iron with a hydrogen rich reducing gas, utilizing a non-fired reducing gas heater to heat the hydrogen rich reducing gas to a temperature sufficient for iron reduction, comprising:
a reduction shaft furnace of a direct reduction plant configured to reduce iron oxide to metallic iron with the hydrogen rich reducing gas;
a scrubber configured to receive a reduction shaft furnace top gas stream comprising spent reducing gas and remove steam and particulates from the spent reducing gas with the scrubber to process the shaft furnace top gas and produce a scrubbed top gas;
a gas separation unit configured to process all or a portion of the scrubbed top gas to create a hydrogen rich stream with its fraction of non-hydrogen compounds reduced, and an inert/oxidant rich stream comprising CO₂, CO, CH₄, H₂ and N₂; and
a recycle line configured to recycle the hydrogen rich stream from the gas separation unit and at least a portion of the scrubbed top gas with hydrogen from another hydrogen rich stream to create the hydrogen rich reducing gas introduced to the shaft furnace, wherein prior to introduction into the shaft furnace, the hydrogen rich reducing gas is configured to be heated in the non-fired reducing gas heater to heat the hydrogen rich reducing gas to 800˜1100° C.

15. The system of claim 14, further comprising a compressor configured to pressurized the scrubbed top gas.

16. The system of claim 14, further comprising another recycle line configured to inject a portion of the inert/oxidant rich stream removed from the gas separation unit into a transition zone of the shaft furnace to carburize the direct reduced iron, after being blended with a hydrocarbon bearing gas.

17. The system of claim 14, further comprising a CO₂ stripper configured to recover purified CO₂ from the inert/oxidant rich stream discharged from the gas separation unit for the scrubbed top gas.

18. A system for producing direct reduced iron with a hydrogen rich reducing gas, utilizing a non-fired reducing gas heater to heat the hydrogen rich reducing gas to a temperature sufficient for iron reduction, comprising:
a reduction shaft furnace of a direct reduction plant configured to reduce iron oxide to metallic iron with the hydrogen rich reducing gas;
a scrubber configured to receive a reduction shaft furnace top gas stream comprising spent reducing gas and remove steam and particulates from the spent reducing gas with the scrubber to process the shaft furnace top gas and produce a scrubbed top gas;
a pressure swing adsorption gas separation unit configured to process all or a portion of the scrubbed top gas to create a dry hydrogen/nitrogen rich stream with its fraction of non-hydrogen or non-nitrogen compounds reduced, and a methane/oxidant rich stream comprising CH₄, CO₂, CO, H₂O, CH₄, H₂ and N₂;
a secondary membrane gas separation unit configured to process the dry hydrogen/nitrogen rich stream and create hydrogen rich stream; and
a recycle line configured to recycle the hydrogen rich stream from the secondary membrane gas separation unit and at least a portion of the scrubbed top gas with hydrogen from another hydrogen rich stream to create the hydrogen rich reducing gas introduced to the shaft furnace, wherein prior to introduction into the shaft furnace, the hydrogen rich reducing gas is configured to be heated in the non-fired reducing gas heater to heat the hydrogen rich reducing gas to 800˜1100° C.

19. The system of claim 18, further comprising a compressor configured to pressurize the scrubbed top gas.

20. A system for producing direct reduced iron with a hydrogen rich reducing gas, utilizing a non-fired reducing gas heater to heat the hydrogen rich reducing gas to a temperature sufficient for iron reduction, comprising:
a reduction shaft furnace of a direct reduction plant configured to reduce iron oxide to metallic iron with the hydrogen rich reducing gas;
a scrubber configured to receive a reduction shaft furnace top gas stream comprising spent reducing gas and remove steam and particulates from the spent reducing gas with the scrubber to process the shaft furnace top gas and produce a scrubbed top gas;
a pressure swing adsorption gas separation unit configured to process all or a portion of the scrubbed top gas to create a dry hydrogen/nitrogen rich stream with its fraction of non-hydrogen or non-nitrogen compounds reduced, and a methane/oxidant rich stream comprising CH₄, CO₂, CO, H₂O, CH₄, H₂ and N₂;
a secondary membrane gas separation unit configured to process the methane/oxidant rich stream to create a methane rich stream; and
an injection line configured to inject the methane/oxidant rich stream from the membrane gas separation unit into a transition zone of the shaft furnace to carburize the direct reduced iron, after being blended with a hydrocarbon bearing gas.

21. The system of claim 14, wherein the gas separation unit is a membrane gas separator.

22. The system of claim 14, wherein the gas separation unit is a pressure swing adsorption gas separation unit.

23. The system of claim 14, wherein the gas separation unit is a cryogenic gas separation unit.

24. The system of claim 17, wherein the CO₂ stripper is an amine absorber or a pressure swing adsorption gas separation unit.

25. The system of claim 14, wherein the non-fired reducing gas heater is an electric heater using electric energy.

26. The system of claim 18, wherein the non-fired reducing gas heater is an electric heater using electric energy.

27. The system of claim 20, wherein the non-fired reducing gas heater is an electric heater using electric energy.
